(19) United States
(12) Patent Application Publication
(10) Pub. No.: US 2021/0297861 A1
(43) Pub. Date: Sep. 23, 2021

(54) METHODS PROVIDING SELECTIVE INTEGRITY PROTECTION AND RELATED RADIO ACCESS NETWORK BASE STATIONS AND MOBILE WIRELESS DEVICES

(71) Applicant: Telefonaktiebolaget LM Ericsson (publ), Stockholm (SE)

(72) Inventors: Prajwol Kumar Nakarmi, SOLLENTUNA (SE); Jose Luis Pradas, STOCKHOLM (SE); Gunnar Bergquist, KISTA (SE)

(21) Appl. No.: 17/261,003

(22) PCT Filed: Aug. 5, 2019
(86) PCT No.: PCT/EP2019/070974

§ 371 Date: Jan. 16, 2021

Related U.S. Application Data
(60) Provisional application No. 62/764,863, filed on Aug. 16, 2018.

(51) Int. Cl. H04W 12/106; H04W 12/03

(52) U.S. Cl. CPC H04W 12/106; H04W 92/10; H04W 12/03

(57) ABSTRACT

A method at a first communication node may provide communication with a second communication node in a wireless communication network. A radio bearer is provided for communication between the first and second communication nodes over a radio interface. A plurality of packets are communicated over the radio bearer between the first and second communication nodes using selective integrity protection so that at least a first packet of the plurality of packets is communicated over the radio bearer with integrity protection and so that at least a second packet of the plurality of packets is communicated over the radio bearer without integrity protection. Related mobile devices and base stations are also discussed.

### TECHNICAL FIELD

The present disclosure relates generally to communications, and more particularly, to wireless communications and related wireless devices and network nodes.

### BACKGROUND

3GPP is the organization which develops standard specifications of mobile networks (including 5G, 4G, 3G, and 2G). FIG. 1 illustrates a simplified version of a mobile 5G network.

The UE (User Equipment) is a mobile device used by the user to wirelessly access the network. The radio access network (RAN) function (or base station denoted as RAN node) is responsible for providing wireless radio communication to the UE and connecting the UE to the core network (CN). The core network function (or node denoted as CN node) is responsible for handling the mobility of the UE, handling the session and traffic steering of the UE, providing policy rules to govern network behavior, interconnecting to a data network, packet routing and forwarding, among many other responsibilities. There are different CN functions or nodes in 5G (5^{th} Generation), e.g., AMF (Access and Mobility Management Function), SMF (Session Management Function), PCF (Policy Control Function), and UPF (User Plane Function).

The 4G (4^{th} Generation) RAN consisted of base stations known as eNBs (E-UTRAN Node Bs or Evolved Node Bs). The 5G RAN (5^{th} Generation RAN), which is called NG-RAN (Next Generation RAN), consists of two types of base stations—one known as gNBs (Next Generation Node Bs) and ng-eNB (next generation eNB). The 4G CN was called EPC (Evolved Packet Core). The 5G CN is called 5GC (5G Core).

The UE interacts with the RAN node over-the-air using a radio interface. The RAN node in turn interacts with the CN using various network interfaces, e.g., in 5G, NG-RAN interacts with AMF using the interface called N2, and with the UPF using the interface called N3. The NG-RAN nodes themselves interact with each other using the Xn interface.

The logical aspects between the UE and the CN (in particular the AMF in 5G CN) is referred to as NAS (non-access stratum) and that between the UE and the RAN is referred to as AS (access stratum). Correspondingly, the security of communication (control plane and user plane, if applicable) are referred to as NAS security and AS security, respectively. The NAS security keys are used to provide ciphering and integrity protection of NAS messages (mostly control plane). Similarly, the AS security keys provide ciphering and integrity protection of AS messages (both control plane and user plane).

Ciphering here means encryption of messages, which makes it infeasible/difficult for unauthorized parties to decrypt and read the original message. Integrity protection here means the sender adding security token or message authentication code (MAC) to the message that the receiver can verify, which makes it infeasible/difficult for unauthorized parties to tamper the original message without the receiver detecting the tampering.

The AS security (i.e., security of control plane and user plane messages over-the-air) is discussed below. FIG. 2 shows the control plane protocol stack for AS in 5G, and FIG. 3 shows the user plane protocol stack for AS in 5G.

Treatment of packets being transmitted on the radio interface (i.e., at AS level) is defined by so called radio bearers. There are two types of radio bearers—one is called DRB (data radio bearer) for user plane messages, and another is called SRB (signalling radio bearer) for control plane messages.

The layer at top (in FIG. 3) is shown as Data layer which carries the user plane messages from various applications (e.g., Internet Protocol (IP) data).

The SDAP (service data adaptation protocol) layer (in FIG. 3) provides many functions to the user plane, such as mapping between a quality of service flow and a DRB, and marking quality of service flow identifier in both downlink and uplink packets.

The RRC (radio resource control) layer (in FIG. 2) provides many functions to the SRBs, such as establishment, maintenance and release of radio (RRC) connection between the UE and gNB, measurement reporting management, and transfer of NAS messages. From a security perspective, the main function of the RRC layer is to provide security key and algorithm management.

The PDCP (packet data convergence protocol) layer (in FIG. 2 and FIG. 3) provides many functions to both the SRBs and the DRBs, such as sequence numbering, transfer of data, and reordering and duplicate detection. From a security perspective, the main function of the PDCP layer is to provide ciphering and integrity protection.

In 4G, SRBs between UEs and eNBs support both ciphering and integrity protection. DRBs between UEs and eNBs in 4G support only ciphering, and not integrity protection. The integrity protection for DRBs in 4G is supported only between so-called RNs (relay nodes) and DeNBs (donor eNBs).

In 5G, SRBs between UEs and gNBs support both ciphering and integrity protection. DRBs between UEs and gNBs in 5G support both ciphering and integrity protection.

The RLC (radio link control), MAC (medium access control), and PHY (physical) layers (in FIG. 2 and FIG. 3) are not discussed further.

Use of integrity protection may increase a requirement for computational resources in a transmitting and/or receiving device, thereby increasing a cost of hardware/software.

### SUMMARY

According to some embodiments of inventive concepts, a method at a first communication node may provide communication with a second communication node in a wireless communication network. A radio bearer may be provided for communication between the first and second communication nodes over a radio interface. A plurality of packets may be communicated over the radio bearer between the first and second communication nodes using selective integrity protection so that at least a first packet of the plurality of packets is communicated over the radio bearer with integrity protection and so that at least a second packet of the plurality of packets is communicated over the radio bearer without integrity protection.

According to some embodiments of inventive concepts, a requirement for computational resources at a communication node and/or network bandwidth may be reduced by providing selective integrity protection.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 is a block diagram illustrating a 5G network;

FIG. 2 is a diagram illustrating an access stratum AS control plane protocol stack in 5G;

FIG. 3 is a diagram illustrating an access stratum AS user plane protocol stack in 5G;

FIG. 4 is a block diagram illustrating a mobile wireless device UE according to some embodiments of inventive concepts;

FIG. 5 is a block diagram illustrating a radio access network RAN base station according to some embodiments of inventive concepts;

FIGS. 6 and 9 are flow charts illustrating operations of base station nodes according to some embodiments of inventive concepts;

FIGS. 7 and 8 are flow charts illustrating operations of mobile wireless devices according to some embodiments of inventive concepts;

FIG. 10 is a block diagram of a wireless network in accordance with some embodiments;

FIG. 11 is a block diagram of a user equipment in accordance with some embodiments

FIG. 12 is a block diagram of a virtualization environment in accordance with some embodiments;

FIG. 13 is a block diagram of a telecommunication network connected via an intermediate network to a host computer in accordance with some embodiments;

FIG. 14 is a block diagram of a host computer communicating via a base station with a user equipment over a partially wireless connection in accordance with some embodiments;

FIG. 15 is a block diagram of methods implemented in a communication system including a host computer, a base station and a user equipment in accordance with some embodiments;

FIG. 16 is a block diagram of methods implemented in a communication system including a host computer, a base station and a user equipment in accordance with some embodiments;

FIG. 17 is a block diagram of methods implemented in a communication system including a host computer, a base station and a user equipment in accordance with some embodiments; and

FIG. 18 is a block diagram of methods implemented in a communication system including a host computer, a base station and a user equipment in accordance with some embodiments.

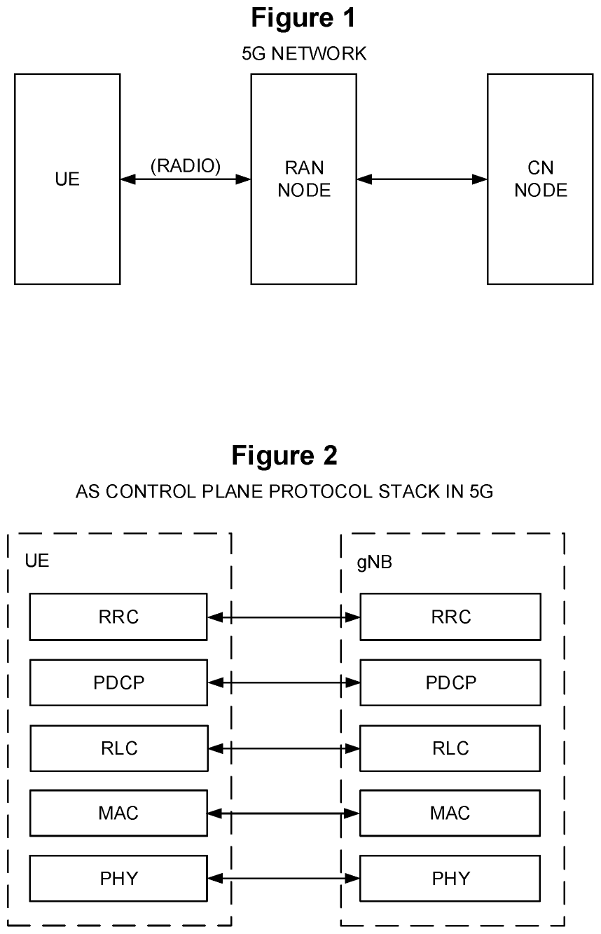

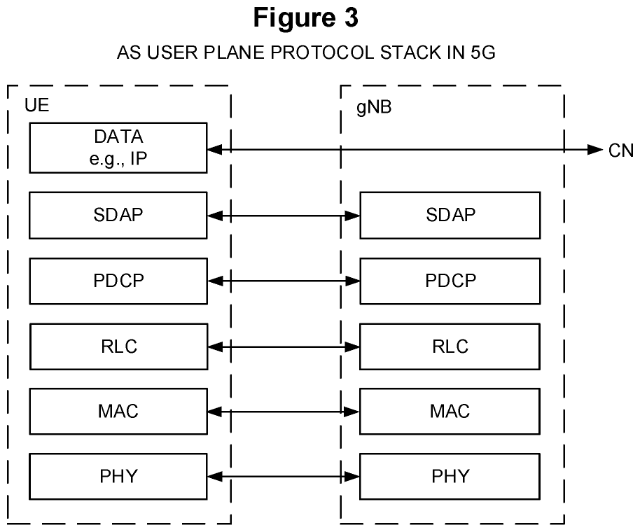

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

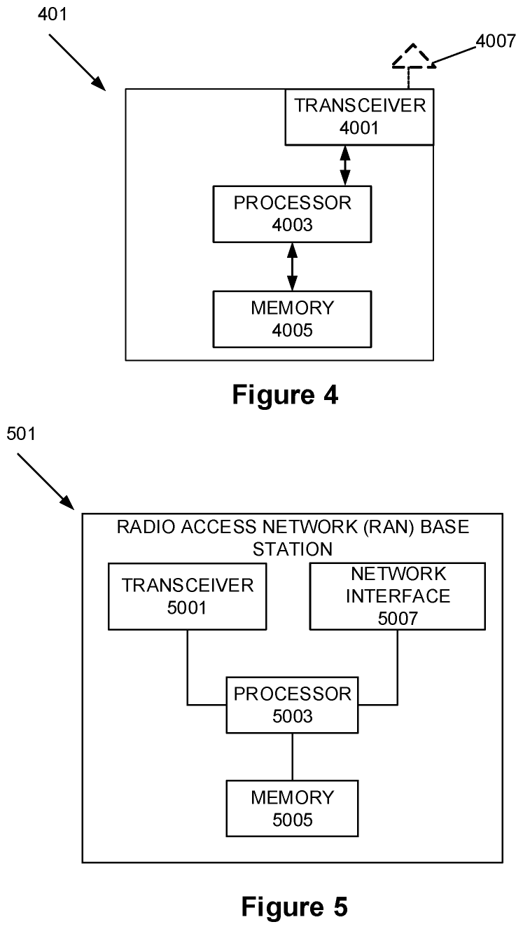

FIG. 4 is a block diagram illustrating elements of a mobile wireless device UE 401 (also referred to as a wireless device, mobile device, wireless terminal, a wireless communication device, a wireless communication terminal, user equipment, UE, a user equipment node/terminal/device, etc.) configured to provide wireless communication according to embodiments of inventive concepts. As shown, wireless device UE may include an antenna 4007, and a transceiver circuit 4001 (also referred to as a transceiver) including a transmitter and a receiver configured to provide uplink and downlink radio communications with a radio access network RAN node (e.g., a base station, eNB, gNB, etc.) of a wireless communication network. Wireless device UE 201 may also include a processor circuit 4003 (also referred to as a processor) coupled to the transceiver circuit, and a memory circuit 4005 (also referred to as memory) coupled to the processor circuit. The memory circuit 4005 may include computer readable program code that when executed by the processor circuit 4003 causes the processor circuit to perform operations according to embodiments disclosed herein. According to other embodiments, processor circuit 4003 may be defined to include memory so that a separate memory circuit is not required. Wireless device UE may also include an interface (such as a user interface) coupled with processor 4003, and/or wireless device UE may be an IoT and/or MTC device.

As discussed herein, operations of wireless device UE 401 may be performed by processor 4003 and/or transceiver 4001. For example, processor 4003 may control transceiver 4001 to transmit uplink communications through transceiver 4001 over a radio interface to a RAN node of a wireless communication network and/or to receive downlink communications through transceiver 4001 from a RAN node of the wireless communication network over a radio interface. Moreover, modules may be stored in memory 4005, and these modules may provide instructions so that when instructions of a module are executed by processor 4003, processor 4003 performs respective operations (e.g., operations discussed below with respect to Example Embodiments).

FIG. 5 is a block diagram illustrating elements of a radio access network RAN base station 501 (also referred to as a network node, RAN node, base station, eNB, eNodeB, gNB, gNodeB, etc.) of a wireless communication network configured to provide cellular communication according to embodiments of inventive concepts. As shown, RAN base station 501 may include a transceiver circuit 5001 (also referred to as a transceiver) including a transmitter and a receiver configured to provide uplink and downlink radio communications with wireless devices. The RAN base station 501 may include a network interface circuit 5007 (also referred to as a network interface) configured to provide communications with other nodes (e.g., with other base stations and/or core network nodes) of the wireless communication network. The RAN node 203 may also include a processor circuit 5003 (also referred to as a processor) coupled to the transceiver circuit, and a memory circuit 5005 (also referred to as memory) coupled to the processor circuit. The memory circuit 5005 may include computer readable program code that when executed by the processor circuit 5003 causes the processor circuit to perform operations according to embodiments disclosed herein. According to other embodiments, processor circuit 5003 may be defined to include memory so that a separate memory circuit is not required.

As discussed herein, operations of the RAN base station 501 may be performed by processor 5003, network interface 5007, and/or transceiver 5001. For example, processor 5003 may control transceiver 5001 to transmit downlink communications through transceiver 5001 over a radio interface to one or more UEs and/or to receive uplink communications through transceiver 5001 from one or more UEs over a radio interface. Similarly, processor 5003 may control network interface 5007 to transmit communications through network interface 5007 to one or more other network nodes and/or to receive communications through network interface from one or more other network nodes. Moreover, modules may be stored in memory 5005, and these modules may provide instructions so that when instructions of a module are executed by processor 5003, processor 5003 performs respective operations (e.g., operations discussed below with respect to Example Embodiments). In addition, a structure similar to that of FIG. 5 may be used to implement other network nodes (e.g., AMF, SMF, UPF, AF, and/or NEF nodes), for example, omitting transceiver 5001. Moreover, network nodes discussed herein may be implemented as virtual network nodes.

In some deployments, providing integrity protection for all DRBs can become a real practical issue, e.g., with legacy hardware or software in UEs (also referred to as mobile wireless devices) and/or in RAN nodes (also referred to as RAN base stations).

The UEs and/or RAN nodes may not have sufficient computational resources where the sender calculates and includes message authentication codes MACs with the messages and the receiver verifies the MACs included by the sender.

The issue may become worse when the data rate is very high.

According to some embodiments, flexible and/or effective solutions for providing integrity protection to DRBs may be provided.

Flexibility may be provided in that integrity protection of DRBs can be customized in various different ways as per need, on a case by case basis.

Effectiveness may be provided in that tampering of DRBs by an over the air attacker can be detected, mitigated, or/or avoided.

In the following disclosure, generally, the terminology and/or functions in 5G are used. It should be appreciated that the following disclosure, however, is not limited to only 5G or only to those terminologies and/or functions.

As discussed earlier, providing integrity protection for all DRBs can become a real practical issue in some deployments, either on UE side or network side or on both sides.

One technique to address this issue is to perform over dimensioning. Over dimensioning means that UEs and/or gNBs are equipped with a high level of computational resources (e.g., including additional hardware accelerators). Over dimensioning, however, may be costly and therefore economically unviable.

Another technique is to use different types of algorithms for different DRBs. This means that integrity protection and verification could be distributed to different software processes or threads, and even to different hardware accelerators. Using different algorithms, however, may not provide significant benefit unless there are different hardware accelerators or computational resources where workload of DRBs can be offloaded, and use of this technique may thus result in issues similar to those discussed above with respect to over dimensioning.

Another technique may be to dynamically activate integrity protection on each of the DRBs. This may be done in 4G for DRBs between RNs and DeNBs. This is also being discussed in 5G for DRBs between UEs and gNBs. It means that only some (among many) DRBs can be activated to have integrity protection. Doing so could work, but not in all scenarios. For example, activating integrity protection on 1 DRB out of 10 DRBs may be a useful flexibility. The UEs and the gNBs could then be able to cope to some extent with the data rate and resource limitation. However, even that 1 DRB could have a data rate that is simply too much for the UE and the gNB to handle.

Yet another technique is to make use of a maximum data rate per UE. This is being discussed in 5G. It means that the UE sends to the network (gNB or core network) the maximum data rate up to which the UE can support integrity protection. The network then keeps track of this maximum data rate per UE and will activate integrity on only those DRBs that have data rate less than or equal to the UE's maximum data rate support. Doing so could work, but not in all scenarios. For example, it could happen that a DRB is carrying security sensitive data and needs integrity protection, but the data rate of that DRB is slightly greater than the maximum data rate supported by the UE. In that case, the integrity protection on that DRB will not be activated and therefore security may be reduced.

Another technique is to use those ciphering algorithms where integrity protection comes simultaneously with ciphering, e.g., using so-called authenticated encryption (AE) or authenticated encryption with associated data (AEAD). It means that when ciphering of DRBs I performed, integrity protection is not an additional overhead. However, doing so may require that those ciphering algorithms are first accepted and specified by 3GPP and it may not address/solve problems for existing algorithms which are more than likely to remain valid for the foreseeable future. Further, new software and/or hardware may be required on both UE side and gNB side for UEs and gNBs that have implemented those ciphering algorithms. Therefore, this technique may result in increased cost.

Now, in the following disclosure, embodiments for UEs and networks to negotiate how DRBs are integrity protected are disclosed. Some data packets in DRBs are more security sensitive than others, and integrity protecting only the more security sensitive ones may allow the UEs and the networks to strike a great balance between security and performance. According to some embodiments, the UEs and the networks may be allowed to negotiate or choose an interspersion pattern (or profile or scheme) of integrity protection for DRBs. Further disclosure may be provided in terms of IPI-profile (integrity protection interspersion profile).

To understand an idea of how IPI-profile strikes a balance between security and performance, an example is provided where a user is trying to log on to a website using the HTTP (Hypertext Transfer Protocol) from his mobile phone.

The user types the website's web address in the mobile phone's web browser. The web address is known as URL (Uniform Resource Locator). The mobile phone then performs a DNS (Domain Name System) lookup, which means sending a DNS request message with the URL and obtaining in a DNS reply message an IP (Internet Protocol) address of the webserver corresponding to the URL. Further communication then proceeds between the mobile phone and the web server hosting the website. The user types his username and password as part of the log on process, and these are sent to the web server.

All the above communications are carried in a DRB. When there is no integrity protection on the DRB, an over-the-air attacker could change the IP address in the DNS reply message to the IP address of a webserver controlled by the attacker. It has been shown that it is feasible to do so even if there is ciphering on the DRB. What happens next, is that the username and password that should have reached the genuine web server, instead reaches the web server controlled by the attacker. The attacker now knows the user's username and password, the attacker may thus use this information to perform fraud.

Now, if the IPI-profile is used in such a way that even though all other data packets in the DRB are not integrity protected, the data packets carrying the DNS reply messages are still always integrity protected, then whenever the attacker tampers the DNS reply message, the user's mobile phone will detect it (which means the PDCP layer will detect an integrity check failure). Then, further communication with the web server controlled by the attacker will not happen.

In this example, the effect of using an IPI-profile is that the security is maintained for sensitive data packets while still reducing computational load on the UE and the network side for other comparatively less-sensitive data packets. Hence, a balance between security and performance may be provided.

Further, in the following disclosure, various ways in which the said IPI-profile can be brought into practice are discussed.

The IPI-profile may be implemented in various modes, such as the IPI-profile indicates that:
integrity protection is ON, or
integrity protection is OFF.

The ON modes and OFF modes could also be combined together, as will be described with respect to IPI-profile instances below.

The IPI-profile may be implemented in various instances according to one or more parts of the data packet, such as discussed below. It should be appreciated that the examples do not limit the teachings of the present disclosure and a person-skilled-in-the-art would appreciate that other IPI-profile modes and other parts of the data packets than what are explicitly mentioned below can be used as well in various combinations.
IPI-profile-uplink-OFF: meaning that all data packets in uplink direction (from UE to gNB) are not integrity protected (e.g., in above mentioned example, a DNS request will not be integrity protected).
IPI-profile-downlink-ON: meaning that all data packets in uplink direction (from gNB to UE) are integrity protected.] (e.g., in above mentioned example, DNS reply will be integrity protected, and attacker cannot easily manipulate the IP address).
IPI-profile-Ethernet-ON: meaning that all data packets carrying Ethernet packets are integrity protected.
IPI-profile-Ethernet-OFF: meaning that all data packets carrying Ethernet packets are not integrity protected.
IPI-profile-IP-ON: meaning that all data packets carrying Internet Protocol (IP) packets are integrity protected.
IPI-profile-IP-100th-ON: meaning that every 100th data packets (i.e., 100th, 200th, 300th, and so on) carrying Internet Protocol (IP) packets are integrity protected. The benefit of doing so is that not every packet needs to be integrity protected in DRBs which means less load on the UE and the network. Mind that 100th is an example, a generalization could mean Nth data packet.
IPI-profile-200th-ON: meaning that every 200th data packets (i.e., 200th, 400th, 600th, and so on) are integrity protected regardless of the type of packets being carried (i.e., regardless of whether or not the data packets are IP packets). Again, mind that 200th is an example, a generalization could mean Nth data packet.
IPI-profile-first-300-KB-ON: meaning that first 300 kilo bytes of data packets are integrity protected regardless of the type of packets being carried (i.e., regardless of whether or not the data packets are IP packets). Mind that 300 kilo bytes is an example, a generalization could mean Nth data packet.
IPI-profile-MOD-100-ON: meaning that every packet whose packet number modulo 100 is zero. For example, if a PDCP counter (e.g. SN) % 100=0, then the packet will be integrity protected.
IPI-profile-IP-900th-950th-ON: meaning that data packets every 900th to 950th (i.e., 900th-950th, 1800th-1850th, 2700th-2750th, and so on) carrying Internet Protocol (IP) packets are integrity protected. The benefit of doing so is that not every packet needs to be integrity protected in DRBs which means less load on the UE and the network. It should be appreciated that 900th-950th is an example, a generalization could mean Start-End for data packets. It should also be appreciated that instead of explicit End, Start-Range could also be used, e.g. 50 packets after every 900th packet.
IPI-profile-900th-950th-ON: meaning that data packets every 900th to 950th (i.e., 900th-950th, 1800th-1850th, 2700th-2750th, and so on) are integrity protected regardless of the type of packets being carried, i.e., regardless of whether or not the data packets are IP packets
IPI-profile-ROHC-IR-ON: meaning that data packets are integrity protected at compressor side when robust header compression (ROHC) is being used and the compressor side is in a ROHC state called IR (initialization and refresh state). In this case, for the IP packets, static data fields like IP packet headers are sent, which include source and destination IP addresses. Integrity protection of the data packet with IP packet header prevents an attacker from tampering with the IP addresses without the receiver noticing the tampering.
IPI-profile-ROHC-SO-OFF: meaning that data packets are not integrity protected at compressor side when ROHC is being used and the compressor side is in a ROHC state called SO (second order state). In this case, static data fields have been identified and only dynamic fields are being sent in compressed form. Hence, turning off integrity protection is relatively acceptable, because the static fields in the IP header have been already communicated securely.
IPI-profile-ROHC-NC-ON: meaning that data packets are integrity verified at decompressor side when robust ROHC is being used and the decompressor side is in a ROHC state called NO (no context state).
IPI-profile-ROHC-FS-OFF: meaning that data packets are not integrity verified at decompressor side when robust ROHC is being used and the decompressor side is in a ROHC state called FS (full context state).
IPI-profile-TCP-ON: meaning that all data packets that use Transmission Control Protocol (TCP) as transport protocol are integrity protected.
IPI-profile-UDP-OFF: meaning that all data packets that use User Datagram Protocol (UDP) as transport protocol are not integrity protected. The UDP protocol generally carries large volume of data. So, turning skipping integrity protection of DRBs is less sensitive than it would have been for low volume data.
IPI-profile-TCP-PORT-80-ON: meaning that all data packets that use TCP port 80 (either source or destination port) are integrity protected. Port 80 is popularly used for HTTP (Hypertext Transfer Protocol) protocol.
IPI-profile-TCP-PORT-443-OFF: meaning that all data packets that use TCP port 443 (either source or destination port) are not integrity protected. Port 443 is popularly used for HTTPS (Hypertext Transfer Protocol Secure) protocol. Since security is already provided by HTTPS, integrity protection of DRBs would be mean yet another layer of protection, which can be skipped.
IPI-profile-TCP-HTTP-ON: meaning that all data packets that use HTTP (Hypertext Transfer Protocol) over TCP as application protocol are integrity protected.
IPI-profile-TCP-HTTPS-OFF: meaning that all data packets that use HTTPS (Hypertext Transfer Protocol Secure) over TCP as application protocol are not integrity protected. Since security is already provided by HTTPS, integrity protection of DRBs would be mean yet another layer of protection, which can be skipped.
IPI-profile-UDP-DNS-ON: meaning that all data packets that use DNS (Domain Name System) over UDP as application protocol are integrity protected.
IPI-profile-TCP-TLS-OFF: meaning that all data packets that use TLS (Transport Layer Security) over TCP as application protocol are not integrity protected. Since security is already provided by TLS, integrity protection of DRBs would be mean yet another layer of protection, which can be skipped.

Generalizing a IPI-profile, an IPI-profile may contain one or more of the following characteristics or indications as examples:
If it applies to downlink (DL), uplink (UL), or both
The integrity protection activation status to apply (i.e., to activate, or to not activate, or to deactivate integrity protection)
Type of traffic for which integrity protection is activated/deactivated (e.g., ethernet, IP, TCP, UDP, port etc.)
Traffic characteristics for which integrity protection is activated/deactivated (e.g., ROHC activation status, TCP ports, HTTPS, etc.)
Indication of the amount of packets which are integrity protected and/or how often integrity protection is applied to packets (e.g., see above IPI-profile-200th-ON, IPI-profile-MOD-100-ON, IPI-profile-IP-900th-950th-ON).
The type of packets which are considered, e.g., only IP packets, only ROHC packets, PDCP data packets, etc.
Indication of the first packet for which integrity protection should be applied (e.g., SN of the first packet integrity protected). This may be implicitly known, for example, if it is being given by a modulo operation (e.g. IPI-profile-MOD-100-ON)

The IPI-profile could be controlled by one or more parts in the network. It should be appreciated that functions and/or nodes that control the IPI-profile may be different for different embodiments of inventive concepts. Nevertheless, some examples follow.

The gNB (or NG-RAN) could choose a particular instance of IPI-profile for a particular DRB based on its own local policy (e.g., use IPI-profile-UDP-OFF because the gNB does not have enough resources such as hardware accelerators). It could also be the core network (like AMF, SMF, PCF, or even UPF) that choses the IPI-profile based on various aspects (e.g., user's subscription, quality of service, type of data session, etc.).

The IPI-profile could be negotiated or indicated or communicated between the UE and the network in various ways. It should be appreciated that procedures and/or messages used to negotiate the IPI-profile may be different for different embodiments of inventive concepts. Nevertheless, some examples follow.

The gNB (or NG-RAN) and the UE could use a procedure called the access stratum security mode command procedure (AS SMC procedure). It works as follows. The gNB sends the IPI-profile to the UE in a message called AS security mode command. This AS security mode command message is integrity protected and therefore an attacker cannot easily tamper with the sent IPI-profile without the UE noticing it. The UE sends confirmation to the gNB by sending a message called AS security mode complete. The IPI-profile in this case is used by the UE and the gNB for all DRBs that will be created later.

The gNB (or NG-RAN) and the UE could use a procedure called radio resource control connection reconfiguration procedure (RRC connection reconfiguration procedure). It works as follows. The gNB sends one or more IPI-profiles to the UE in a message called RRC connection reconfiguration. This RRC connection reconfiguration message is integrity protected and therefore an attacker cannot easily tamper with the sent IPI-profiles without the UE noticing it. The UE sends confirmation to the gNB by sending a message called RRC connection reconfiguration complete. In this case, there could be multiple IPI-profiles for each DRB that is being created.

When the core network controls the IPI-profile, the core network (such as PCF, SMF, AMF, UPF) could communicate the chosen IPI-profile to the gNB (NG-RAN) so that gNB could further indicate the chosen IPI-profile via say RRC connection reconfiguration procedure.

When the core network controls the IPI-profile, the core network could also communicate the chosen IPI-profile directly to the UE in, for example, a protocol data unit (PDU) session establishment accept message.

The UE and the network must have a common understanding with regards to which packets are integrity protected and which are not. Therefore, any reconfiguration and initialization of the IPI profile may imply that the UE and the network need to know which packets will be or will not be integrity protected. Failure to do so may lead to protocol failures.

Typically, this type of reconfigurations may imply that the PDCP, RLC, and MAC entities need to flush their buffers and rely in either PDCP recovery or even higher layers if those options are possible. Otherwise, the reconfiguration may lead to packet losses.

If IPI profile is meant to be changed very frequently depending on the network and/or UE processing resources, it may not be acceptable to have packet losses every time there is a reconfiguration.

Some example mechanisms of how the UE and the network can get a common understanding of integrity protected packets, to reduce/avoid undesirable packet losses, are listed below:
1. RRC provides the IPI-profiles and their corresponding identifier together with the characteristics of each of the profiles. It may also configure an initial IPI-profile and the activation status.
2. Another layer (e.g. PDCP) may activate, deactivate, change the IPI-profile from the list of IPI-profiles.
   a. The message sent by this another layer could provide information which allows the receiver side to know when is the first or last packet which is integrity protected or, the first or last packet which is not integrity protected. Additionally, the message could indicate the IPI-profile to use from those indicated in the RRC message.
   b. Alternatively, the receiver could implicitly know when the first/last packet which is integrity protected or not protected arrives. This message could be acknowledged by the receiver entity before a new configuration can be applied.
   c. The PDCP layer gets a confirmation from lower layers when the RLC (Radio Link Control) packets have been received by the other end. This applies to RLC AM (Acknowledged Mode), but not to UM (Unacknowledged Mode). So, for RLC AM, the PDCP entity in the transmitter has the best knowledge about when the configuration is applied in the first PDU. The PDCP entity could inform the receiver side about the first PDCP PDU (Protocol Data Unit) which is sent with the new configuration by, for example, indicating the SN (Sequence Number) of the last PDU which had the old configuration, or the first PDU which carries the new.

According to some embodiments, a method for integrity protection of user plane traffic between a 3GPP mobile device and a 3GPP radio network access node may thus include using information of how integrity protection is interspersed among user plane traffic. The information may be an integrity protection interspersion profile indicated by the network to the device.

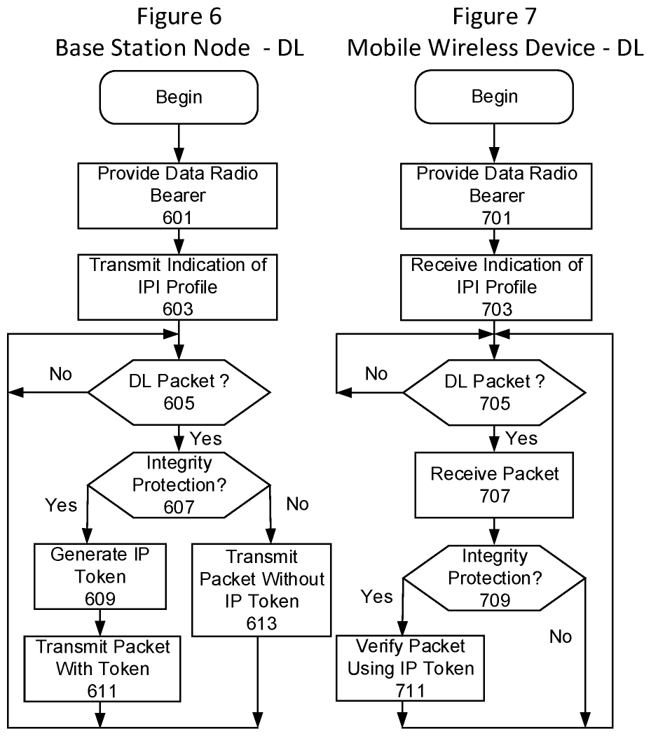

Downlink operations of RAN base station 501 will now be discussed with reference to the flow chart of FIG. 6. For example, modules may be stored in RAN base station memory 5005 of FIG. 5, and these modules may provide instructions so that when the instructions of a module are executed by processor 5003, processor 5003 performs respective operations of the flow chart of FIG. 6.

At block 601, processor 5003 may provide a data radio bearer for communication between RAN base station 501 and mobile wireless device 401 over a radio interface. At block 603, processor 5003 may transmit an indication of an integrity protection interspersion profile through transceiver 5001 to wireless mobile device 401.

At block 605, processor 5003 may determine if a downlink packet is available for transmission. When a downlink packet is available for transmission, processor 5003 may determine at block 607 if integrity protection is to be applied to the downlink packet in accordance with the integrity protection interspersion profile indicated at block 603. For downlink packets for which integrity protection is to be applied at block 607, processor 5003 generates an integrity protection token for the downlink packet based on data of the downlink packet at block 609, and processor 5003 transmits the downlink packet with the integrity protection token through transceiver 5001 over the data radio bearer to mobile wireless device 401 at block 611. For downlink packets for which integrity protection is not to be applied at block 607, processor 5003 transmits the downlink packet without integrity protection through transceiver 5001 over the data radio bearer to mobile wireless device 401 at block 613.

According to embodiments of FIG. 6, RAN base station 501 may thus transmit a plurality of downlink packets in the downlink over the data radio bearer to wireless mobile device 401 using selective integrity protection so that at least a first downlink packet of the plurality of downlink packets is transmitted over the data radio bearer with integrity protection and so that at least a second downlink packet of the plurality of downlink packets is transmitted over the data radio bearer without integrity protection.

Various operations from the flow chart of FIG. 6 may be optional with respect to some embodiments of base stations and related methods. Regarding methods of example embodiment 1 (set forth below), for example, operations of blocks 603, 605, 607, and 609 of FIG. 6 may be optional.

Downlink operations of mobile wireless device 401 will now be discussed with reference to the flow chart of FIG. 7. For example, modules may be stored in memory 4005 of FIG. 4, and these modules may provide instructions so that when the instructions of a module are executed by processor 4003, processor 4003 performs respective operations of the flow chart of FIG. 7.

At block 701, processor 4003 may provide a data radio bearer for communication between mobile wireless device 401 and RAN base station 501 over a radio interface. At block 703, processor 4003 may receive an indication of an integrity protection interspersion profile. The indication of the integrity protection interspersion profile may be received from RAN base station 501 through transceiver 4001 (e.g., the indication discussed above with respect to block 603 of FIG. 6).

At block 705, processor 4003 may determine if a downlink packet has been transmitted from RAN base station 501. When a downlink packet has been transmitted from RAN base station 501, processor 4003 may receive the downlink packet from RAN base station 501 over the data radio bearer through transceiver 4001 at block 707. At block 709, processor 4003 may determine if integrity protection applies to the received downlink packet based on the integrity protection interspersion profile indicated at block 703. If integrity protection applies to the received downlink packet at block 709, processor 4003 may verify an integrity of data of the downlink packet based on an integrity protection token included in the downlink packet at block 711. If integrity protection does not apply to the received downlink packet at block 709, processor 4003 may receive the downlink packet without performing verification.

According to embodiments of FIG. 7, mobile wireless device 401 may thus receive a plurality of downlink packets over the data radio bearer from RAN base station 501 using selective integrity protection so that at least a first downlink packet of the plurality of downlink packets is received over the data radio bearer with integrity protection and so that at least a second downlink packet of the plurality of downlink packets is communicated over the data radio bearer without integrity protection.

Various operations from the flow chart of FIG. 7 may be optional with respect to some embodiments of base stations and related methods. Regarding methods of example embodiment 1 (set forth below), for example, operations of blocks 703, 705, 709, and 711 of FIG. 7 may be optional.

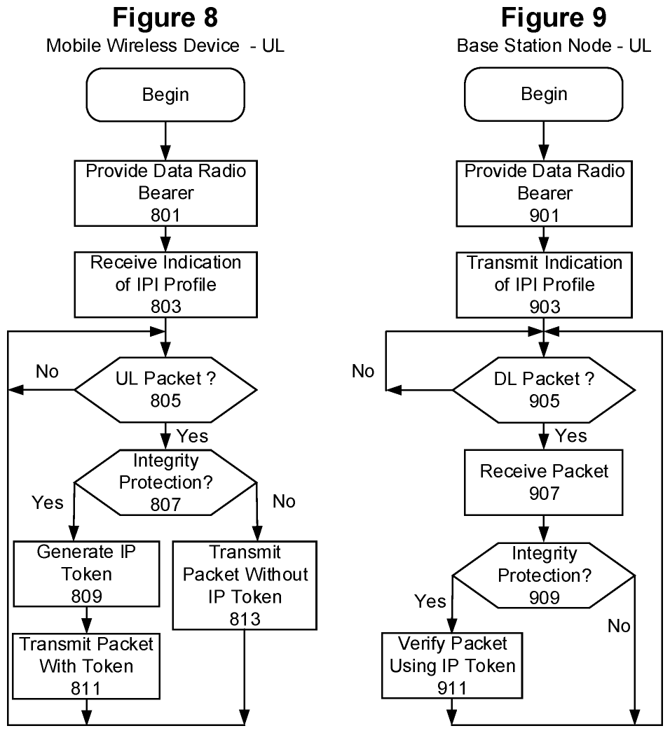

Uplink operations of mobile wireless device 401 will now be discussed with reference to the flow chart of FIG. 8. For example, modules may be stored in memory 4005 of FIG. 4, and these modules may provide instructions so that when the instructions of a module are executed by processor 4003, processor 4003 performs respective operations of the flow chart of FIG. 8.

At block 801, processor 4003 may provide a data radio bearer for communication between mobile wireless device 401 and RAN base station 501 over a radio interface. At block 803, processor 4003 may receive an indication of an integrity protection interspersion profile. The indication of the integrity protection interspersion profile may be received from RAN base station 501 through transceiver 4001.

At block 805, processor 4003 may determine if an uplink packet is available for transmission. When an uplink packet is available for transmission, processor 4003 may determine at block 807 if integrity protection is to be applied to the uplink packet in accordance with the integrity protection interspersion profile indicated at block 803. For uplink packets for which integrity protection is to be applied at block 807, processor 4003 generates an integrity protection token for the uplink packet based on data of the uplink packet at block 809, and processor 4003 transmits the uplink packet with the integrity protection token through transceiver 4001 over the data radio bearer to RAN base station 501 at block 811. For uplink packets for which integrity protection is not to be applied at block 807, processor 4003 transmits the uplink packet without integrity protection through transceiver 4001 over the data radio bearer to RAN base station 501 at block 813.

According to embodiments of FIG. 8, mobile wireless device 401 may thus transmit a plurality of uplink packets over the data radio bearer to RAN base station 501 using selective integrity protection so that at least a first uplink packet of the plurality of uplink packets is communicated over the data radio bearer with integrity protection and so that at least a second uplink packet of the plurality of uplink packets is communicated over the data radio bearer without integrity protection.

Various operations from the flow chart of FIG. 8 may be optional with respect to some embodiments of base stations and related methods. Regarding methods of example embodiment 1 (set forth below), for example, operations of blocks 803, 805, 807, and 809 of FIG. 8 may be optional.

Uplink operations of RAN base station 501 will now be discussed with reference to the flow chart of FIG. 9. For example, modules may be stored in RAN base station memory 5005 of FIG. 5, and these modules may provide instructions so that when the instructions of a module are executed by processor 5003, processor 5003 performs respective operations of the flow chart of FIG. 9.

At block 901, processor 5003 may provide a data radio bearer for communication between RAN base station 501 and mobile wireless device 401 over a radio interface. At block 903, processor 5003 may transmit an indication of an integrity protection interspersion profile through transceiver 5001 to mobile wireless device 401. The indication of block 903 may correspond to the indication of block 803 of FIG. 8.

At block 905, processor 5003 may determine if an uplink packet has been transmitted from mobile wireless device 401. When an uplink packet has been transmitted from mobile wireless device 401, processor 5003 may receive the uplink packet from mobile wireless device 401 over the data radio bearer through transceiver 5001 at block 907. At block 909, processor 5003 may determine if integrity protection applies to the received uplink packet based on the integrity protection interspersion profile indicated at block 903. If integrity protection applies to the received uplink packet at block 909, processor 5003 may verify an integrity of data of the uplink packet based on an integrity protection token included in the uplink packet at block 911. If integrity protection does not apply to the received uplink packet at block 909, processor 5003 may receive the uplink packet without performing verification.

According to embodiments of FIG. 9, RAN base station 501 may thus receive a plurality of uplink packets over the data radio bearer from mobile wireless device 401 using selective integrity protection so that at least a first uplink packet of the plurality of uplink packets is communicated over the data radio bearer with integrity protection and so that at least a second uplink packet of the plurality of uplink packets is communicated over the data radio bearer without integrity protection.

Various operations from the flow chart of FIG. 9 may be optional with respect to some embodiments of base stations and related methods. Regarding methods of example embodiment 1 (set forth below), for example, operations of blocks 903, 905, 909, and 911 of FIG. 9 may be optional.

Example embodiments of inventive concepts are set forth below.

1. A method at a first communication node providing communication with a second communication node in a wireless communication network, the method comprising: providing (601, 701, 801, 901) a radio bearer for communication between the first and second communication nodes over a radio interface; and communicating (611, 613, 707, 811, 813, 907) a plurality of packets over the radio bearer between the first and second communication nodes using selective integrity protection so that at least a first packet of the plurality of packets is communicated over the radio bearer with integrity protection and so that at least a second packet of the plurality of packets is communicated over the radio bearer without integrity protection.

2. The method of Embodiment 1, wherein the radio bearer is a data radio bearer.

3. The method of any of Embodiments 1-2, wherein the plurality of packets comprises a plurality of user plane packets.

4. The method of any of Embodiments 1-3, wherein the plurality of packets comprises a plurality of protocol data units.

5. The method of any of Embodiments 4, wherein the plurality of protocol data units comprises a plurality of packet data convergence protocol data units.

6. The method of any of Embodiments 1-5, wherein communicating the first data packet with integrity protection comprises communicating the first data packet with an integrity protection token.

7. The method of Embodiment 6, wherein the integrity protection token comprises a message authentication code.

8. The method of any of Embodiments 6-7, further comprising: generating (609, 809) the integrity protection token based on data of the first data packet; wherein communicating comprises transmitting (611, 811) the first data packet including the data and the integrity protection token to the second communication node.

9. The method of any of Embodiments 6-7, wherein communicating comprises receiving (707, 907) the first data packed including the integrity protection token and data of the first data packet from the second communication node, the method further comprising: verifying (711, 911) an integrity of the data of the first data packet based on the integrity protection token.

10. The method of any of Embodiments 6-9, wherein communicating comprises transmitting the second data packet without integrity protection to the second communication node.

11. The method of any of Embodiments 6-9, wherein communicating comprises receiving the second data packet without integrity protection from the second communication node.

12. The method of any of Embodiments 1-11, wherein the selective integrity protection is provided for the plurality of packets according to an integrity protection interspersion profile.

13. The method of any of Embodiments 12, wherein the integrity protection interspersion profile provides that integrity protection is provided for a pattern of data packets, and wherein the first data packet is included in the pattern of data packets and is communicated over the radio bearer with integrity protection.

14. The method of any of Embodiments 12-13, wherein the integrity protection interspersion profile provides integrity protection for the downlink, wherein the first packet is communicated over the radio bearer with integrity protection on the downlink.

15. The method of any of Embodiments 12-14, wherein the integrity protection interspersion profile provides that integrity protection is not provided for the uplink, wherein the second packet is communicated over the radio bearer without integrity protection on the uplink.

16. The method of any of Embodiments 12-13, wherein the integrity protection interspersion profile provides integrity protection for the uplink, wherein the first packet is communicated over the radio bearer with integrity protection on the uplink.

17. The method of any of Embodiments 12, 13, and 15, wherein the integrity protection interspersion profile provides that integrity protection is not provided for the downlink, wherein the second packet is communicated over the radio bearer without integrity protection on the downlink.

18. The method of any of Embodiments 12-17, wherein the integrity protection interspersion profile provides integrity protection for packets of a packet type, wherein the first packet is of the packet type and is communicated over the radio bearer with integrity protection.

19. The method of any of Embodiments 12-17, wherein the integrity protection interspersion profile provides that integrity protection is not provided for packets of a packet type, wherein the second packet is of the packet type and is communicated over the radio hearer without integrity protection.

20. The method of any of Embodiments 18-19, wherein the packet type comprises at least one of ethernet packet type, an Internet Protocol packet type, a Transmission Control Protocol packet type, a User Datagram Protocol packet type, a Hypertext Transfer Protocol packet type, a Domain Name System protocol packet type, and/or a Transport Layer Security protocol packet type.

21. The method of any of Embodiments 12-20, wherein the integrity protection interspersion profile provides integrity protection for packets using a designated port, wherein the first packet is communicated over the radio bearer using the designated port with integrity protection.

22. The method of any of Embodiments 12-20, wherein the integrity protection interspersion profile provides that integrity protection is not provided for packets using a designated port, wherein the second packet is communicated over the radio hearer using the designated port without integrity protection.

23. The method of any of Embodiments 21-22, wherein the designated port comprises at least one of Transmission Control Protocol port 80 and/or Transmission Control Protocol port 443.

24. The method of any of Embodiments 12-23, wherein the integrity protection interspersion profile provides integrity protection for Domain Name System packets, and wherein the first packet is a Domain Name System packet that is communicated over the radio bearer with integrity protection.

25. The method of any of Embodiments 12-24, wherein the integrity protection interspersion profile provides that integrity protection is not provided for Transport Security Layer packets, and wherein the second packet is a Transport Security Layer packet that is communicated over the radio bearer without integrity protection.

26. The method of any of Embodiments 12-25, wherein the integrity protection interspersion profile provides integrity protection for robust header compression initialization and refresh state packets, and wherein the first data packet is a robust header compression initialization and refresh state packet that is communicated over the radio bearer with integrity protection.

27. The method of any of Embodiments 12-26, wherein the integrity protection interspersion profile provides that integrity protection is not provided for robust header compression second order state packets, and wherein the second packet is a robust header compression second order state packet that is communicated over the radio bearer without integrity protection.

28. The method of any of Embodiments 12-27, wherein the integrity protection interspersion profile provides that integrity protection is provided periodically for packets of the plurality of packets.

29. The method of Embodiment 28, wherein integrity protection is provided periodically so that integrity protection is provided for packets of the plurality of packets that are divisible by an integer n.

30. The method of Embodiment 28, wherein the integrity protection interspersion profile provides that integrity protection is provided periodically for a range of packets.

31. The method of Embodiment 12, wherein the integrity protection interspersion profile provides integrity protection based on at least one of: downlink; uplink; integrity protection activation status; traffic type; traffic characteristic; a number of packets to be protected; a periodicity of packets to be protected; a packet type; and/or an indication of a first packet in a group to be protected.

32. The method of any of Embodiments 12-31 further comprising:

communicating (603, 703, 803, 903) an indication of the integrity protection interspersion profile between the first and second communication nodes.

33. The method of any of Embodiments 1-32, wherein the first communication node comprises a mobile wireless device, and wherein the second communication node comprises a radio access network, RAN, base station.

34. The method of any of Embodiments 1-32, wherein the first communication node comprises a radio access network, RAN, base station, and wherein the second communication node comprises a mobile wireless device.

35. A mobile wireless device (401) adapted to perform according to any of Embodiments 1-33.

36. mobile wireless device (401) comprising: a processor (4003); and memory (4005) coupled with the processor, wherein the memory includes instructions that when executed by the processor causes the RAN node to perform operations according to any of Embodiments 1-33.

37. A computer program product, comprising: a non-transitory computer readable storage medium comprising computer readable program code embodied in the medium that when executed by a processor (4003) of a mobile wireless device (401) causes the mobile wireless device to perform operations according to any of Embodiments 1-33.

38. A Radio Access Network, RAN, base station (501) of a wireless communication network, wherein the RAN base station is adapted to perform according to any of Embodiments 1-32 and 34.

39. A Radio Access Network, RAN, base station (501) of a wireless communication network, the RAN node comprising: a processor (5003); and memory (5005) coupled with the processor, wherein the memory includes instructions that when executed by the processor causes the RAN node to perform operations according to any of Embodiments 1-32 and 34.

40. A computer program product, comprising: a non-transitory computer readable storage medium comprising computer readable program code embodied in the medium that when executed by a processor (5003) of a radio access network, RAN, base station (501) causes the RAN nod base station to perform operations according to any of Embodiments 1-32 and 34.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

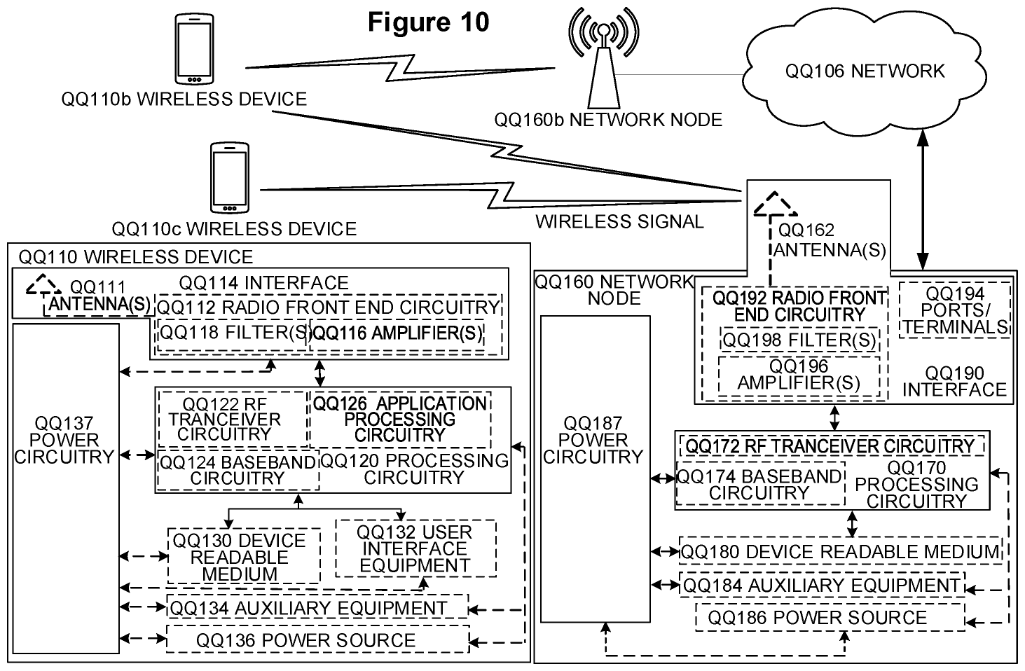

FIG. 10: A wireless network in accordance with some embodiments.

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network QQ106, network nodes QQ160 and QQ160b, and WDs QQ110, QQ110b, and QQ110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 10 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated. User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

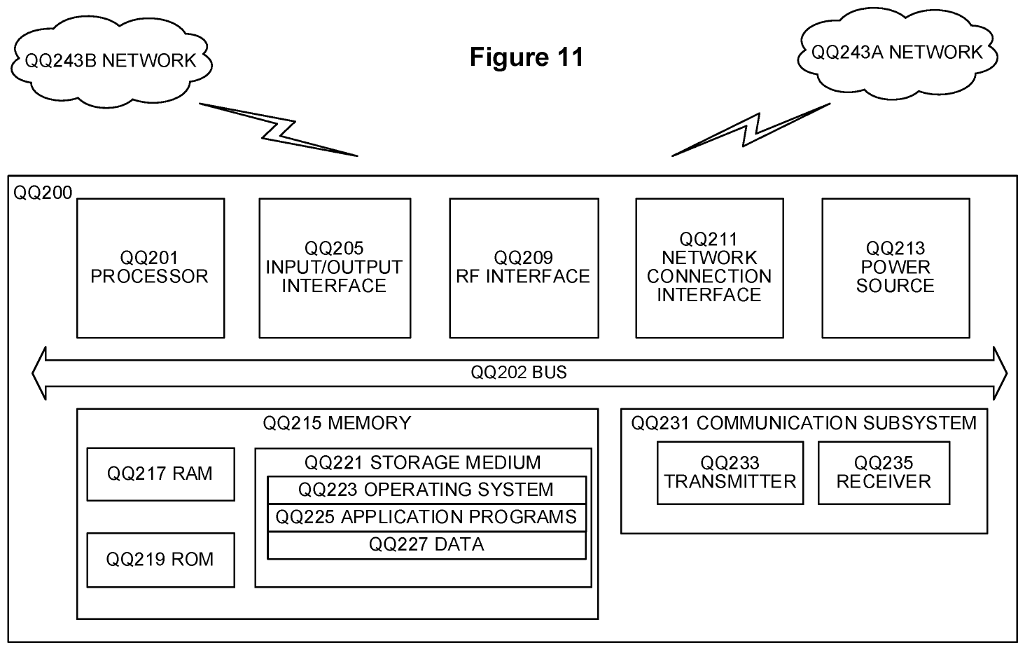

FIG. 11: User Equipment in accordance with some embodiments

FIG. 11 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3rd Generation Partnership Project (3GPP), including a NB-IoT UE, a machine type communication (MTC) UE, and/or an enhanced MTC (eMTC) UE. UE QQ200, as illustrated in FIG. 11, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 11 is a UE, the components discussed herein are equally applicable to a WD, and vice-versa.

In FIG. 11, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 11, or only a subset of the components. The level of integration between the components may vary from one UE to another UE. Further, certain UEs may contain multiple instances of a component, such as multiple processors, memories, transceivers, transmitters, receivers, etc.

In FIG. 11, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 11, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. 11, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

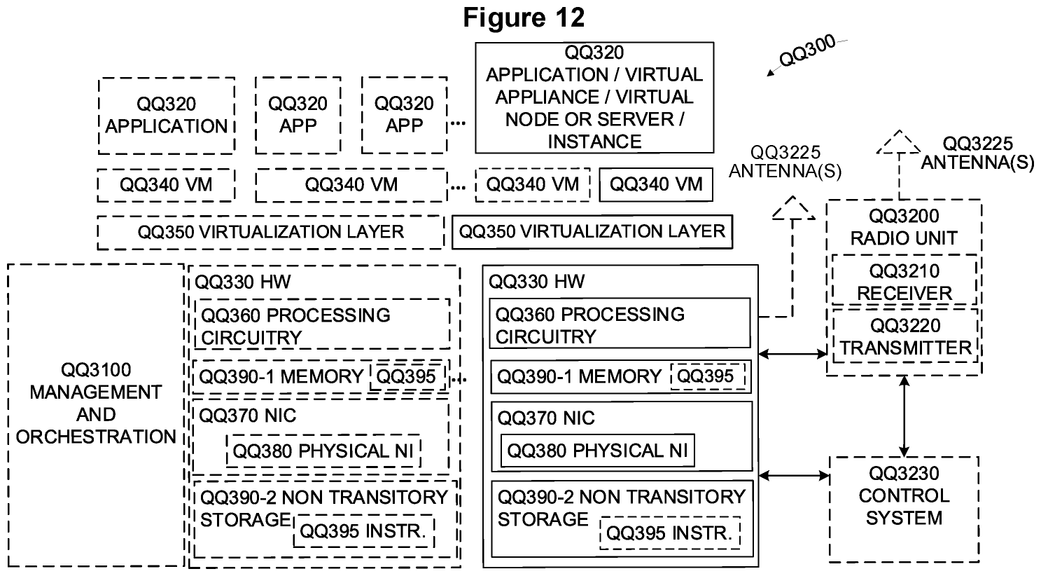

FIG. 12: Virtualization environment in accordance with some embodiments

FIG. 12 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 12, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 12.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

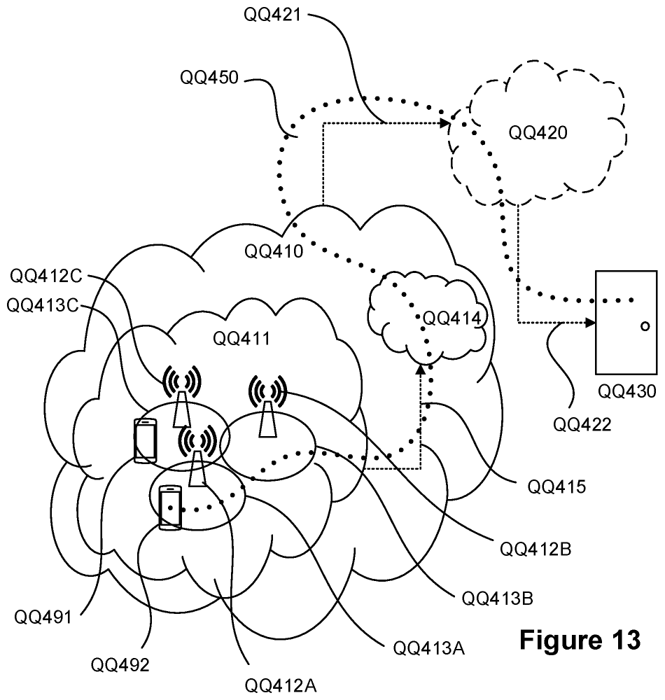

FIG. 13: Telecommunication network connected via an intermediate network to a host computer in accordance with some embodiments.

With reference to FIG. 13, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 13 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

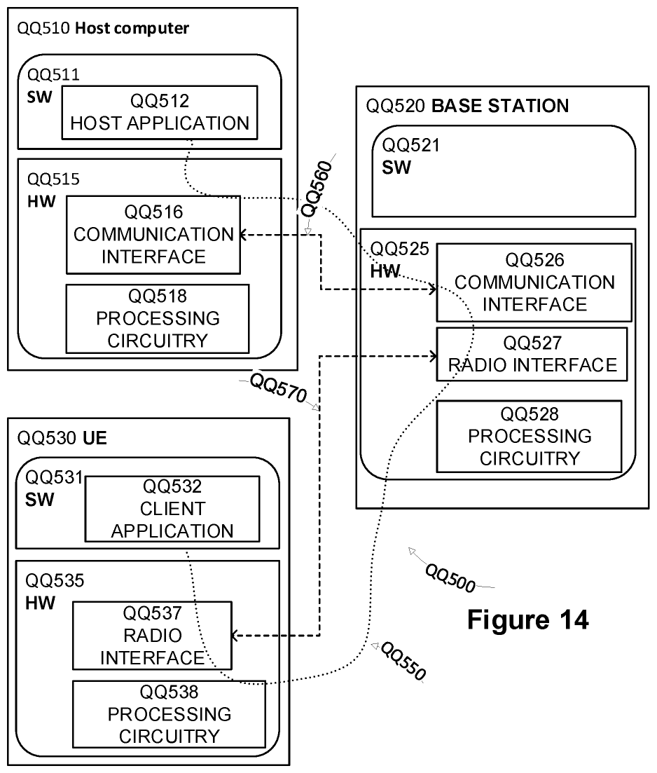

FIG. 14: Host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 14. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 14) served by base station QQ520. Communication interface QQ526 may be configured to facilitate connection QQ560 to host computer QQ510. Connection QQ560 may be direct or it may pass through a core network (not shown in FIG. 14) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 14 may be similar or identical to host computer QQ430, one of base stations QQ412a, QQ412b, QQ412c and one of UEs QQ491, QQ492 of FIG. 13, respectively. This is to say, the inner workings of these entities may be as shown in FIG. 14 and independently, the surrounding network topology may be that of FIG. 13.

In FIG. 14, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments may improve the performance of OTT services provided to UE QQ530 using OTT connection QQ550, in which wireless connection QQ570 forms the last segment. More precisely, the teachings of these embodiments may improve the deblock filtering for video processing and thereby provide benefits such as improved video encoding and/or decoding.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

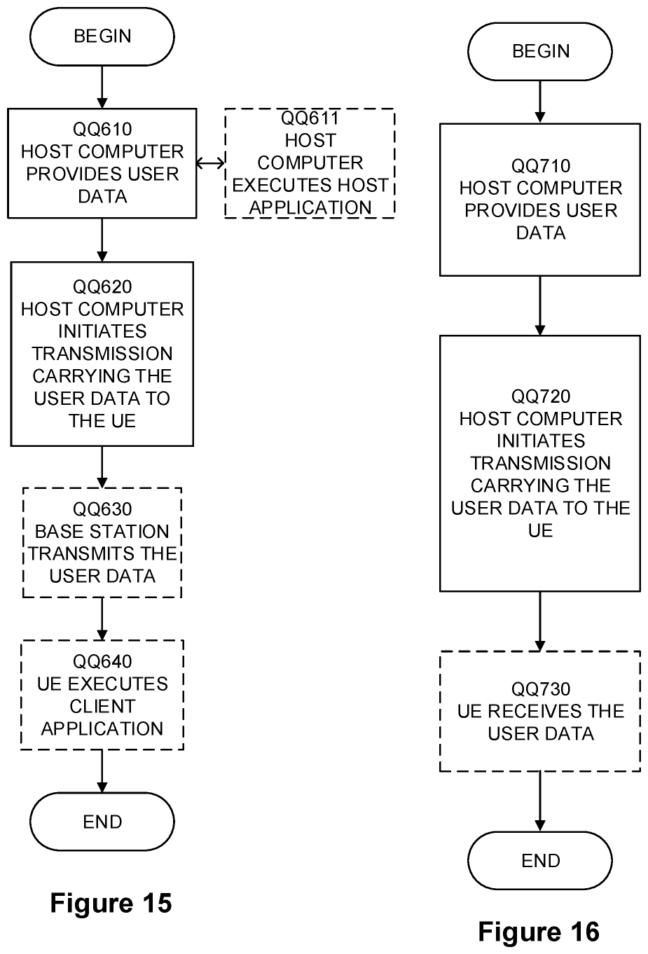

FIG. 15: Methods implemented in a communication system including a host computer, a base station and a user equipment in accordance with some embodiments.

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

FIG. 16: Methods implemented in a communication system including a host computer, a base station and a user equipment in accordance with some embodiments.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

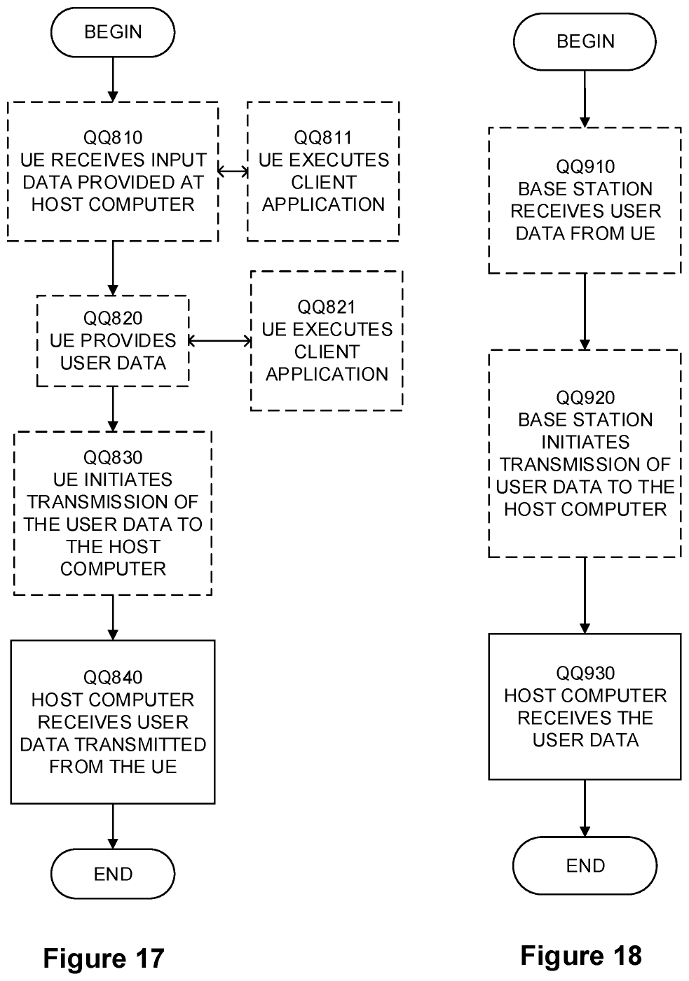

FIG. 17: Methods implemented in a communication system including a host computer, a base station and a user equipment in accordance with some embodiments.

FIG. 17 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 17 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

FIG. 18: Methods implemented in a communication system including a host computer, a base station and a user equipment in accordance with some embodiments.

FIG. 18 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 18 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method at a first communication node providing communication with a second communication node in a wireless communication network, the method comprising:
providing a radio bearer for communication between the first and second communication nodes over a radio interface; and
communicating a plurality of packets over the radio bearer between the first and second communication nodes using selective integrity protection so that at least a first packet of the plurality of packets is communicated over the radio bearer with integrity protection and so that at least a second packet of the plurality of packets is communicated over the radio bearer without integrity protection.

2-5. (canceled)

6. The method of claim 1, wherein communicating the first data packet with integrity protection comprises communicating the first data packet with an integrity protection token.

7. (canceled)

8. The method of claim 6, further comprising:
generating the integrity protection token based on data of the first data packet;
wherein communicating comprises transmitting the first data packet including the data and the integrity protection token to the second communication node.

9. The method of claim 6, wherein communicating comprises receiving the first data packed including the integrity protection token and data of the first data packet from the second communication node, the method further comprising:
verifying an integrity of the data of the first data packet based on the integrity protection token.

10. The method of claim 6, wherein communicating comprises transmitting the second data packet without integrity protection to the second communication node.

11. The method of claim 6, wherein communicating comprises receiving the second data packet without integrity protection from the second communication node.

12. The method of claim 1, wherein the selective integrity protection is provided for the plurality of packets according to an integrity protection interspersion profile.

13. The method of claim 12, wherein the integrity protection interspersion profile provides that integrity protection is provided for a pattern of data packets, and wherein the first data packet is included in the pattern of data packets and is communicated over the radio bearer with integrity protection.

14. The method of claim 12, wherein the integrity protection interspersion profile provides integrity protection for the downlink, wherein the first packet is communicated over the radio bearer with integrity protection on the downlink.

15. The method of claim 12, wherein the integrity protection interspersion profile provides that integrity protection is not provided for the uplink, wherein the second packet is communicated over the radio bearer without integrity protection on the uplink.

16. The method of claim 12, wherein the integrity protection interspersion profile provides integrity protection for the uplink, wherein the first packet is communicated over the radio bearer with integrity protection on the uplink.

17. The method of claim 12, wherein the integrity protection interspersion profile provides that integrity protection is not provided for the downlink, wherein the second packet is communicated over the radio bearer without integrity protection on the downlink.

18. The method of claim 12, wherein the integrity protection interspersion profile provides integrity protection for packets of a packet type, wherein the first packet is of the packet type and is communicated over the radio bearer with integrity protection.

19. The method of claim 12, wherein the integrity protection interspersion profile provides that integrity protection is not provided for packets of a packet type, wherein the second packet is of the packet type and is communicated over the radio hearer without integrity protection.

20. The method of claim 18, wherein the packet type comprises at least one of ethernet packet type, an Internet Protocol packet type, a Transmission Control Protocol packet type, a User Datagram Protocol packet type, a Hypertext Transfer Protocol packet type, a Domain Name System protocol packet type, and/or a Transport Layer Security protocol packet type.

21. The method of claim 12, wherein the integrity protection interspersion profile provides integrity protection for packets using a designated port, wherein the first packet is communicated over the radio bearer using the designated port with integrity protection.

22. The method of claim 12, wherein the integrity protection interspersion profile provides that integrity protection is not provided for packets using a designated port, wherein the second packet is communicated over the radio hearer using the designated port without integrity protection.

23. (canceled)

24. The method of claim 12 further comprising:
communicating an indication of the integrity protection interspersion profile between the first and second communication nodes.

25. (canceled)

26. A mobile wireless device comprising:
a processor; and
memory coupled with the processor, wherein the memory includes instructions that when executed by the processor causes the RAN node to perform operations according to claim 1.

27-28. (canceled)

29. A Radio Access Network, RAN, base station of a wireless communication network, the RAN node comprising:
a processor; and
memory coupled with the processor, wherein the memory includes instructions that when executed by the processor causes the RAN node to perform operations according to claim 1.

30. (canceled)
